(19) United States
(12) Patent Application Publication
(10) Pub. No.: US 2026/0225873 A1
(43) Pub. Date: Aug. 6, 2026

(54) Portable fueling system mountable to a truck bed and method thereof

(71) Applicant: Les Industries Desjardins Ltee, St-Andre (CA)

(72) Inventors: Luc Desjardins, St-Andre (CA); Denis Montminy, St-Andre (CA); Patrick Chouinard, St-Andre (CA); Eric Beaulieu, St-Andre (CA); Serge Fournier, St-Andre (CA)

(21) Appl. No.: 19/530,680

(22) Filed: Feb. 5, 2026

Related U.S. Application Data
(60) Provisional application No. 63/754,249, filed on Feb. 5, 2025.

(51) Int. Cl. B67D 7/84; B67D 7/04

(52) U.S. Cl. CPC B67D 7/845; B67D 7/04

(57) ABSTRACT

A portable fueling system mountable to a truck bed is provided. The fueling system comprises a fuel reservoir, side mounting brackets attachable to the reservoir and a fuel delivery assembly connected to the fuel reservoir and mounted to the side mounting brackets. The fueling system has a height equal or lower to the height of the truck bed. The reservoir may comprise brackets protruding from a top portion of the reservoir, the side mounting brackets being attached to the brackets of the reservoir and may comprise a protection assembly attached in front of the reservoir. The protection assembly may comprise an enclosure between a front wall of the protection assembly and a front wall of the reservoir. The portable fueling system may comprise a rising assembly forming a storage area under the fueling system.

### CROSS-REFERENCE TO RELATED APPLICATIONS

The present patent application claims the benefits of priority of United States Provisional Patent Application No. 63/754,249, entitled “PORTABLE FUELING SYSTEM MOUNTABLE TO A TRUCK BED AND METHOD THEREOF”, and filed at the United States Patent and Trademark Office on February 5, 2025, the content of which is incorporated herein by reference.

### FIELD OF THE INVENTION

The present invention generally relates to portable fuel tank systems for vehicles and methods to carry fuel. More particularly, the present invention relates to fuel tank system carried by trucks or light trucks, such as pickup truck, and to methods for carrying fuel in trucks or light trucks.

### BACKGROUND OF THE INVENTION

Portable fuel tanks are commonly used to supply fuel, such as diesel fuel, to generators or equipment in remote areas, such as construction sites or camps. The fuel tanks or refueling systems are typically installed in a bed of a pickup truck. However, existing refueling systems have several limitations. Many are too large, exceeding the height of the side walls of the pickup truck bed. As such, bed covers may not be closed over the refueling system to cover and protect the content of the bed.

Additionally, traditional fuel tanks are typically mounted directly on the truck bed. In such arrangement, the tank uses a substantial area of the bed of the truck. Therefore, the available volume of the bed of the truck is also substantially limited. The limited remaining volume typically prevents storage of bulky and/or long materials or objects, such as planks, logs, tools, etc.

Prior art fuel tank comprises a fuel delivery system including a hose. When not in used or during transportation, the hose is loose in the remaining volume of the bed leading to disorganization and potential damage to the hose and/or delivery system of the fuel tank.

Fuel delivery systems of the prior art are also unprotected or prone to be damaged by elements or objects being carried in the bed or being adjacent to the refueling system.

Accordingly, there is thus a need for a refueling system mountable to a vehicle which optimize the volume of the bed of the truck. There is also a need for a refueling system being located under a cover of bed of a truck. Furthermore, there is a need for a refueling system allowing carrying of bulky and oversized objects or materials within the bed of the truck. There is further a need for a mountable refueling system comprising a security perimeter to avoid damages to the tank and/or a storing system for the refueling delivery unit.

### SUMMARY OF THE INVENTION

The shortcomings of the prior art are generally mitigated by a portable fueling system that is mountable to a truck bed.

The system comprises a fuel reservoir, a fuel delivery assembly, and side mounting brackets. The system is designed to fit within the bed of a pickup truck and maintain a height that allows for a bed cover to fit over it.

The fueling system comprises a tank or reservoir made of durable material, such as certified steel, with support brackets for lifting, an inlet cap for refilling, a fuel outlet positioned on top, a vent, and an access aperture for installing a fuel level indicator. The fuel delivery assembly includes a pump unit, a fuel conduit, and a nozzle assembly. The system also features mounting brackets that attach the delivery assembly to the tank. A rising assembly may be used to elevate the system, creating storage space under the reservoir. Additionally, a protection assembly may be included, consisting of a front wall to protect the fuel system from impacts, side brackets, and a bottom portion for securing the hose when not in use.

In one aspect of the invention, a portable fueling system mountable to a truck bed is provided. The system comprises a fuel reservoir having a top portion, a fuel delivery assembly connected to the fuel reservoir and mounted the top portion of the fuel reservoir, wherein the fueling system has a height equal or lower to the height of the truck bed.

The portable fueling system may further comprise side mounting brackets, the fuel delivery assembly being mounted to the side mounting brackets.

The portable fueling system of may comprise brackets protruding from the top portion of the reservoir, the side mounting brackets being attached to the brackets of the reservoir. The nozzle assembly may be attached to the side mounting brackets below the top portion of the fuel reservoir. The portable fueling system may comprise two lower side mounting brackets attached to one or more lips of the fuel reservoir.

The portable fueling system may comprise a protection assembly attached in front of the reservoir to prevent physical damages to the reservoir from items stored in the truck bed. The protection assembly may comprise an enclosure between a front wall of the protection assembly and a front wall of the reservoir. The enclosure may have a volume great enough to receive a dispensing hose of the fuel delivery assembly. The portable fueling system may comprise two lower side mounting brackets attached to one or more lips of the fuel reservoir, the protection assembly being attached to the lower side mounting brackets.

The portable fueling system may comprise a rising assembly forming a storage area under the fueling system. The rising assembly may comprise support members attached on at least two sides of the fueling system. The support members may be C-shaped. The rising assembly may be attached to one or more lips of the fuel reservoir. The portable fueling system may comprise two lower side mounting brackets attached to one or more lips of the fuel reservoir, the rising assembly being attached to the lower side mounting brackets. The fuel reservoir may be covered by a cover of the bed truck.

In yet another aspect of the present invention, a method for carrying fuel under a covered truck bed is provided. The method comprises attaching a fuel reservoir in the truck bed, the fuel reservoir having a height equal or lower than the height of the truck bed and covering the bed truck and the fuel reservoir.

The method may further comprise attaching a nozzle of the fuel reservoir below a top portion of the fuel reservoir. The method may comprise mounting a fuel delivery system of the fuel reservoir below the top portion of the fuel reservoir. The method may further comprise storing a fuel hose of the fuel reservoir within a front protecting assembly. The method of claim may further comprise the attachment of the fuel reservoir to allow an empty space under the fuel reservoir for storage.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 a perspective view of an embodiment of a refueling system mountable to a vehicle according to the principles of the present invention.

FIG. 2 is a top plan view of the refueling system of FIG. 1.

FIG. 3 is left side elevation view of the refueling system of FIG. 1.

FIG. 4 is a front elevation view of the refueling system of FIG. 1.

FIG. 5 is a detailed perspective view of an embodiment of a fuel delivery system of the refueling system of the section A of FIG. 1

FIG. 6 is a detailed rear view of an embodiment of a ground supporting portion of the refueling system of FIG. 1.

FIG. 7 is a perspective view of another embodiment of a refueling system mountable to a vehicle according to the principles of the present invention, shown with a refueling gun mounted on a front bumper and without a rising assembly.

FIG. 8 is a top plan view of the refueling system of FIG. 7.

FIG. 9 is a left side elevation view of the refueling system of FIG. 7.

FIG. 10 is a front elevation view of the refueling system of FIG. 7.

FIG. 11 is a detail view of an embodiment of a fuel delivery system for the refueling system of the section A of FIG. 7.

FIG. 12 is a detailed front view of an embodiment of a ground supporting portion of the refueling system of FIG. 7.

FIG. 13 is a perspective view of yet another embodiment of a refueling system mountable to a vehicle according to the principles of the present invention, shown with a refueling gun mounted to a side bracket and with a rising assembly.

FIG. 14 is a detail view of an embodiment of a fuel delivery system for the refueling system of the section A of FIG. 13.

FIG. 15 is a front view of another embodiment of a refueling system mountable to a vehicle according to the principles of the present invention, shown with a refueling gun mounted to a side bracket and without a rising assembly.

### DETAILED DESCRIPTION OF THE INVENTION

A novel portable fueling system mountable to a truck bed and method thereof will be described hereinafter. Although the invention is described in terms of specific illustrative embodiments, it is to be understood that the embodiments described herein are by way of example only and that the scope of the invention is not intended to be limited thereby.

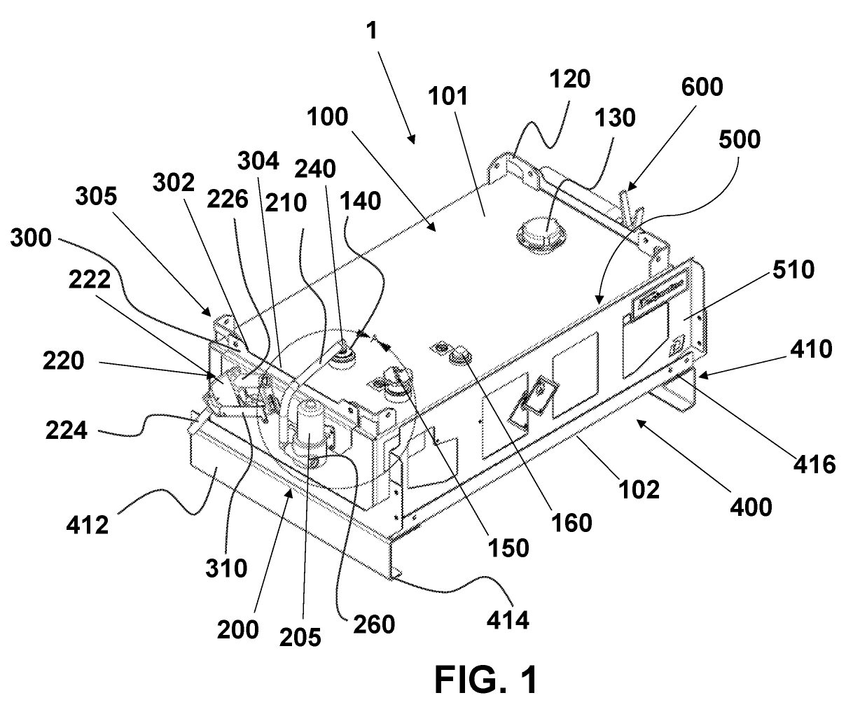

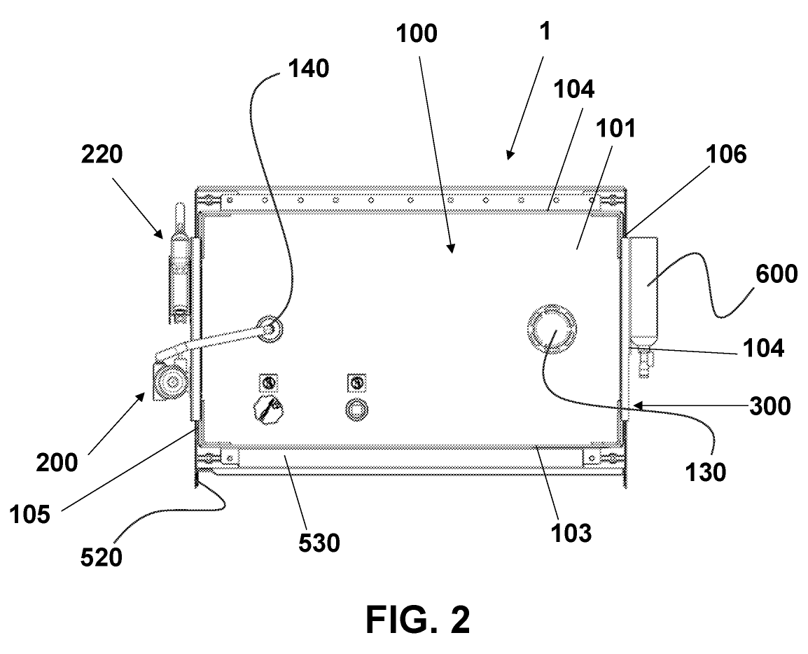

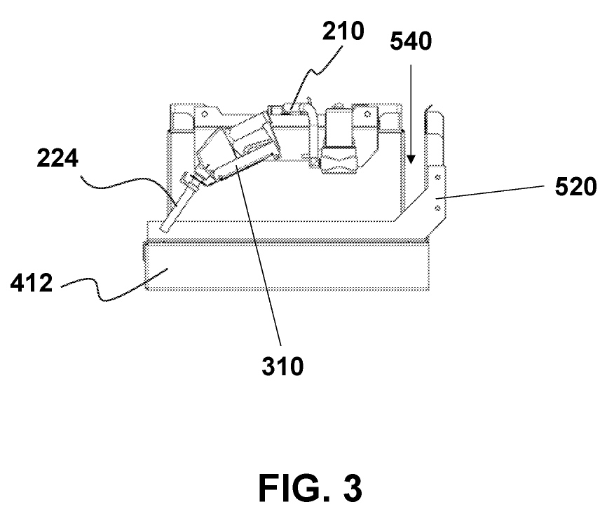

Referring first to FIGS. 1-5, an embodiment of a portable fueling system 1 is illustrated. The fueling system 1 is sized to fit within a bed of a truck. In a preferred embodiment, the truck is a pickup truck. As such, the height of the system 1 shall not exceed the height of the side wall of the bed of the truck to allow a bed cover to fit over the system 1. The fueling system 1 generally comprises a tank or reservoir 100, a fuel delivery assembly 200, and side mounting brackets 300 attachable to the tank 100. The fuel reservoir 100 is adapted to store fuel, is typically made of hard and resistant material, such as certified steel or other metal. The fuel reservoir 100 may be compliant with local safety and durability standards.

In the illustrated embodiment, the tank or reservoir 100 is shaped as a rectangular parallelepiped comprising a top and bottom portions 101 and 102, a front wall 103, a rear wall 104 and side walls 105 and 106. The top portion 101 comprises support brackets 120, typically positioned at the corners of the fuel reservoir 100. The support brackets 120 are solidly attached or are welded to the reservoir 100. As such, the fueling system 1 may be safely lifted by attaching chains or a lifting machine (not shown) to the support brackets 120. The reservoir 100 may further comprise an inlet cap 150, generally positioned on the top portion 101 of the fuel reservoir 100. The inlet cap 150, when removed, allows refilling of the reservoir 100.

In the illustrated embodiment, the reservoir 100 further comprises a fuel outlet 140, typically on the top surface 101 of the reservoir 100. The fuel outlet 140 is generally positioned to comply with safety certification requirements requiring outlets and inlets of a fuel reservoir to be positioned on top to prevent potential leaks or spills. The reservoir 100 may further comprise a vent 130 and an aperture 160. The aperture 160 may be adapted to receive a fuel level indicator (not shown).

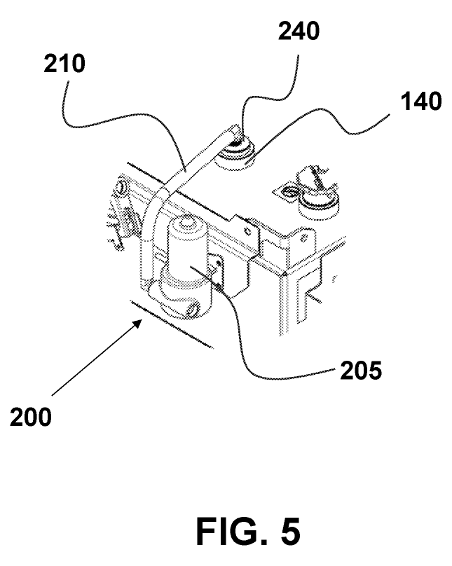

Referring now to FIG. 5, an embodiment of a fuel delivery assembly 200 is shown without a hose. The fuel delivery assembly 200 comprises a pump unit 205, a fuel conduit 210 connecting the reservoir 100 to the pump unit 205, a fuel nozzle assembly 220 connected to the pump unit 205 with a flexible hose (not shown). In the illustrated embodiment, the fuel delivery assembly 200 is mounted to one of the side walls 105 or 106 of the reservoir 100. In a preferred embodiment, the fuel delivery assembly 200 is mounted to one or more mounting brackets 300 attachable to the reservoir 100. The mounting of the fuel delivery assembly 200 to the side 105 or 106 of the reservoir 100 generally aims at maintaining the height of the fueling system 1 to be equal or under side walls of the truck bed (not shown).

The fuel conduit 210 generally ensures a secure and leak-proof transfer of fuel from the reservoir 100 to the pump assembly 200. The fuel conduit 210 may be connected to the outlet 140 with a cap having a fitting 240. The fitting 240 is typically made of rigid material to withstand the pressure generated by the pump assembly 200 during fuel delivery operations.

The fuel delivery assembly 200 may further comprise a dispensing hose (not shown) connecting the fuel pump unit 205 to a nozzle 220. The nozzle 220 and hose allow delivering of fuel to external equipment or vehicles. As illustrated, the fuel nozzle assembly 220 comprises a body portion 222, a nozzle tip 224 and operation lever 226. Understandably, any type of known fuel nozzle assembly 220 may be used within the scope of the present invention.

In the illustrated embodiment, the mounting brackets 300 are rigidly attached to support bracket 120 of the reservoir 100. One skilled in the art shall understand that the reservoir 100 may not be perforated by a fastener to fix the brackets or other supporting elements as it would create leaking points in the said reservoir 100. The support bracket 300 is shaped to conform with the side 105 or 106 of the reservoir 100, such as being generally Z-shaped or S-shaped. The top 305 of the bracket 300 may comprise a recess portion 304 providing clearance on the top 101 of the reservoir 100. The bracket 300 may further comprise a fuel nozzle holder 310. The fuel nozzle holder 310 is rigidly attached to the bracket 300. The fuel nozzle holder 310 is typically shaped to mate with a bottom portion of the nozzle 220. Understandably, any shape of the holder 310 allowing supporting the nozzle 220 is within the scope of the present invention. The tip 224 generally directs fuel flow during dispensing, while the lever 226 generally enables the user to control the flow rate. An inlet coupling (not shown) connects the nozzle assembly 220 to the dispensing hose. When not in use, the fuel nozzle assembly 300 is stored on the nozzle holder 310.

In some embodiments, the fueling system 1 is solidly mounted to the bed of the truck using any type of fasteners. In other embodiments, such as the one illustrated at FIG. 1, the fueling system 1 comprises a rising assembly 400. The rising assembly 400 supports the fueling system 1. As such, the fueling system 1 is fixed to the rising assembly 400 and the rising assembly 400 is mounted to the bed of the truck. Broadly, the rising assembly 400 generally creates an empty volume under the reservoir 100 of the fuel system 1, allowing items to be stored underneath the system 1. In the illustrated embodiment, the rising assembly 400 comprises two supporting members 410, one on each side of the system 1. Each supporting member 410 typically comprises a side wall or rising portion 412, feet or ground supporting member 414 and a reservoir supporting portion 416. In such embodiment, the reservoir supporting portion of the supporting members 410 are fixed to the underside of the fuel reservoir 100 along the two sides 105 and 106 of the tank 100.

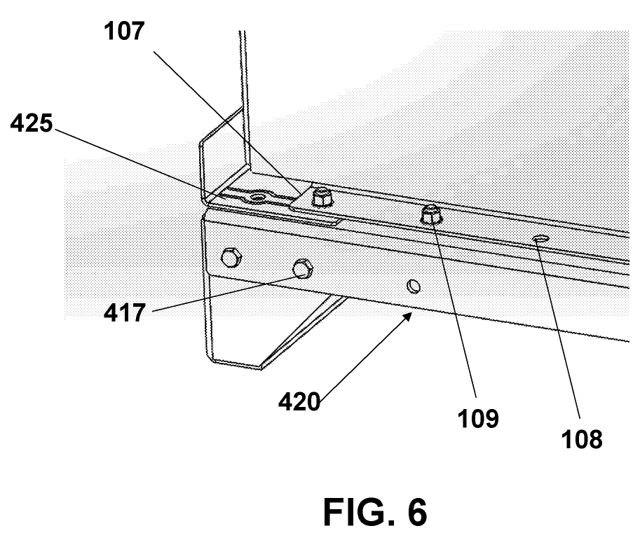

The reservoir may further comprise a lip or ledge 107 protruding from the bottom 102 or side, front or rear walls 103, 104, 105 or 106. The lip 107 may comprise apertures 108 adapted to mount the lip portion 107 to the frame 420. The tank 100 may be attached using any type of fasteners 109. The frame 420 may further comprise a side member 425 which may be used as a mounting point for the lip 107. The side member 425 may be L-shaped, as illustrated. As described below, the frame 420 may be attached to the rising assembly 400 to provide a storage volume under the reservoir 100. As shown in the embodiment of FIG. 6, the feet or ground supporting members 414 may be fixed to the frame 420 using any type of fasteners 417, such as bolts and nuts.

The supporting members 410 provide clearance under the fuel tank 100, allowing for storage, such as storage of long objects. The supporting members 410 are typically made of rigid material sustaining the load of the fuel system 1 and of the fuel within the reservoir 100. In the illustrated embodiment, the supporting members 410 are C-shaped. Understandably, any other shape of the supporting members 410 allowing clearance under the reservoir 100 is within the scope of the present invention.

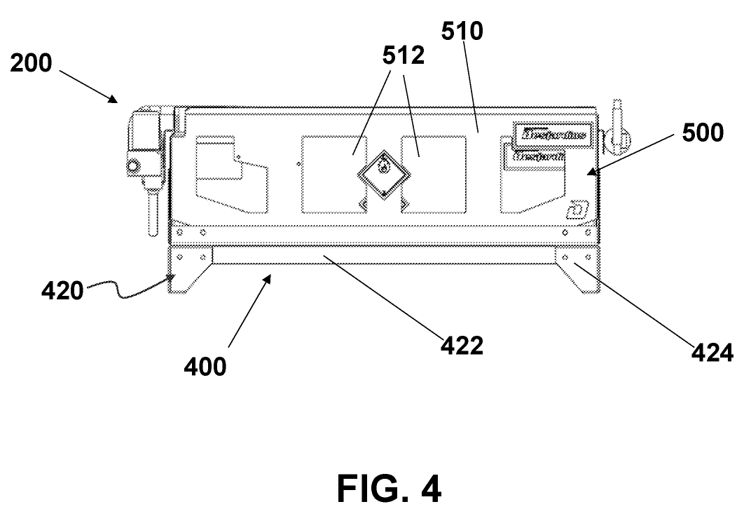

Referring to FIG. 4, the rising assembly 400 may comprise a frame 420 to connect the supporting members 410 to one another. The frame 420 may comprise a rigid longitudinal member 422 and side reinforcing members 424.

In yet other embodiments, the rising assembly 400 may be used in other fueling system 1 having standard heights or having a height higher than the height of the side wall of the truck bed.

Referring back to FIGS. 1-6, in some embodiments, the system 1 may comprise a protection assembly 500. The protection assembly 500 comprises a front wall 510 acting as a protective bumper. In the illustrated embodiment, the front wall 510 may comprise apertures or openings 512. The protection assembly 500 is typically made of a rigid material, such as steel, sustaining impacts from objects present in the bed of the trucks. As such, the protection assembly 500 protects the fueling system 1 from impacts from the tools, materials, or other objects present in the truck bed. The front wall 510 is typically shaped to cover all or a substantial area of the front wall 103 of the reservoir 100. Understandably, the front wall 510 may have any other shape allowing protection of the reservoir 100.

The protection assembly 500 may further comprise side brackets 520. The side brackets 520 are rigidly attached to the front wall 510 and to the fuel system 1 or to the rising assembly 400, if present. The protection assembly 500 may further comprise a bottom portion 530 located between the fueling system 1 and the front wall 510. The bottom portion 530 may be embodied as fold of the front wall 510 or as plate attached to the front wall 510 or the side brackets 520.

In other embodiments, the protection assembly 500 may comprise a channel or enclosure 540. The enclosure 540 is formed between the front wall 510 and the front wall 103 of the reservoir 100. The enclosure 540 is typically used to store the dispensing hose (not shown) when not in use. As an example, the dispensing hose may be folded to fit in the enclosure to be protected from impact of other elements present in the bed of the truck. Understandably, any other tool or element may be stored within the enclosure 540. In the illustrated embodiment, the enclosure 540 is formed by the bottom portion 530, an inner surface of the front wall 510 and an outer surface of the front wall 103 of the reservoir 100.

One skilled in the art shall understand that, in the present embodiment, the protection assembly 500 is has a height aligned with the height of the fuel reservoir 100. As such, the fueling system 1 remains compact and allows use under a truck bed cover. Understandably, the protection assembly 500 may have different sizes and may be installed on any fueling system 1 having heights higher than the height of the walls of the bed.

In such embodiment, the dispensing hose is stored neatly in a hose channel 540 located at the front of the fueling system 1. In use, one may retrieve the dispensing hose from the enclosure 540, pull the lever of the nozzle 220 and start fueling an external equipment or vehicle. When not in use, the dispensing hose securely stored within the hose channel 540 to prevent damage or tangling during transport.

Still referring to FIGS. 1-4, in yet other embodiments, the support bracket 300 may support other accessories or objects, such as a fire extinguisher 600. In such embodiment, the support bracket 300 comprises a fire extinguisher bracket 320. The fire extinguisher bracket 320 is adapted to securely hold a fire extinguisher 600.

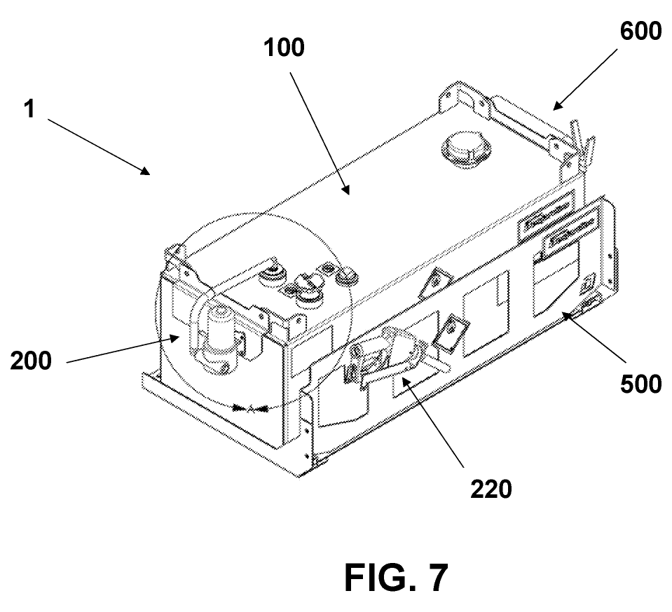

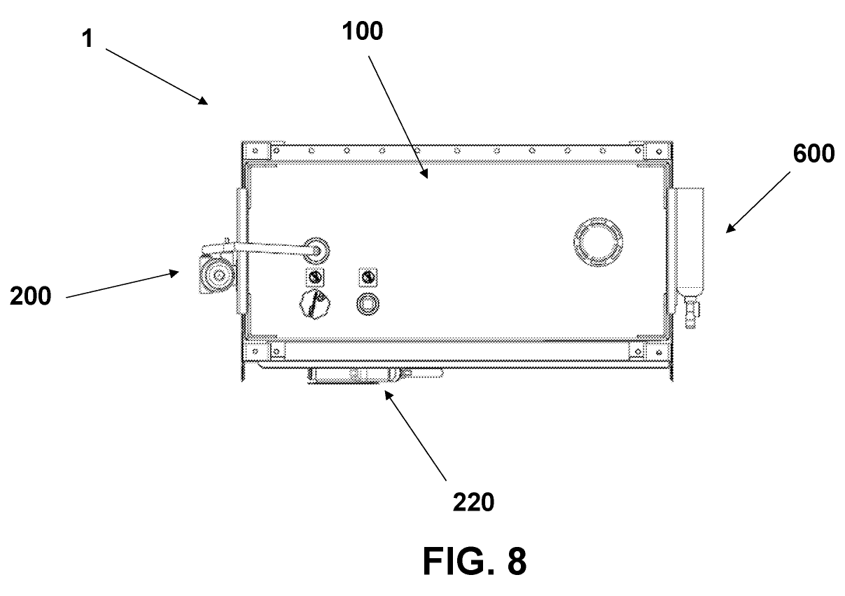

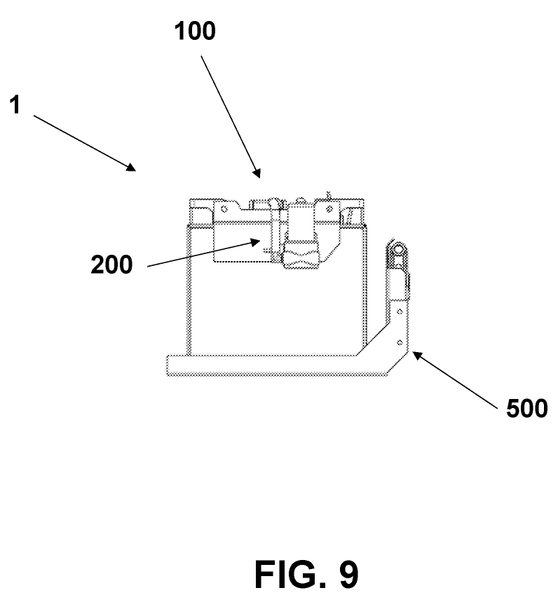

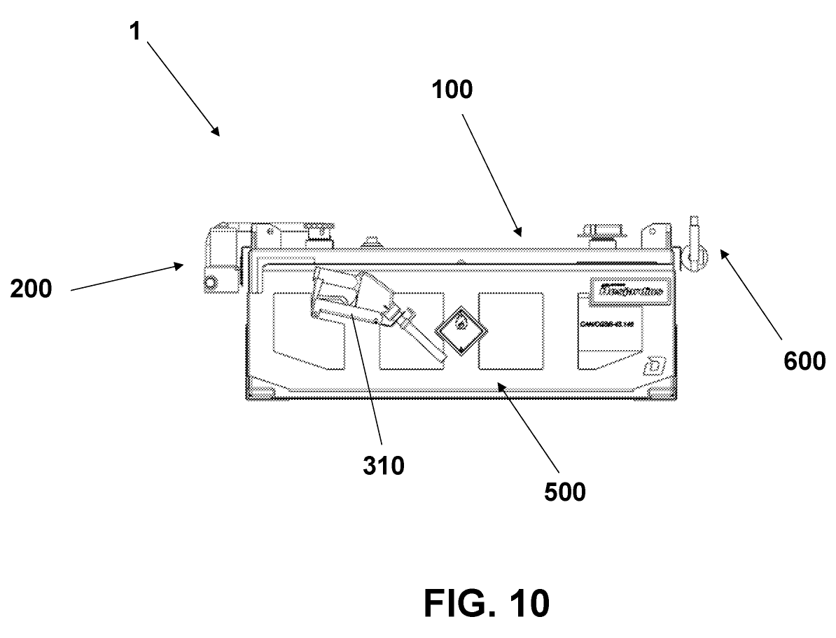

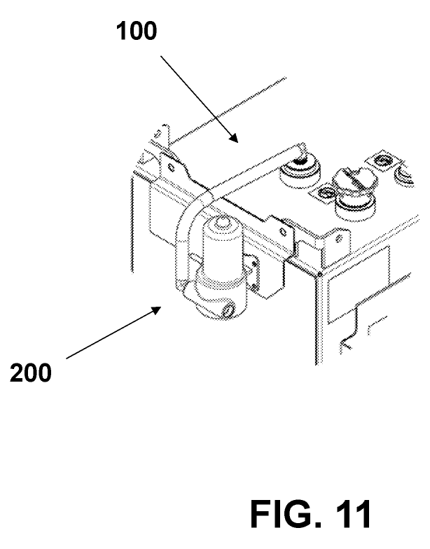

Referring now to FIGS. 7-12, another embodiment of the fueling system 1 is illustrated. In such embodiment, the fuel nozzle holder 310 is attached to an outer surface of the front side 510 of the protection assembly 500. As such, the nozzle protrudes within the bed of the truck. Such configuration generally aims at improving access to the fuel nozzle 220 from the front of the fueling system 1. Such location may be advantageous when the fueling system 1 is installed near the side wall of a truck bed or in other constrained environments.

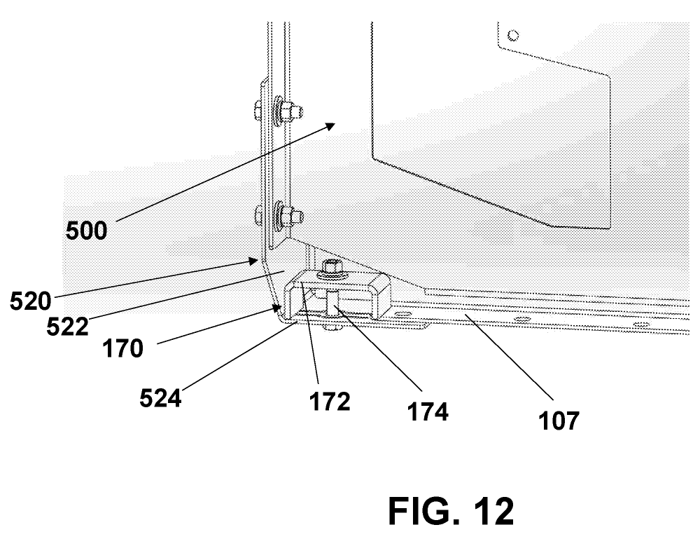

Referring now to FIG. 12, a detailed view of a bottom corner of the front wall 510 acting as a protective bumper is illustrated. In such embodiment, the system 1 does not comprise a rising assembly 400. Understandably, in other embodiment, a rising assembly 400 may be mounted to the system 1. In the present embodiment, the side bracket 520 comprises a side portion 522 and a bottom portion 524. The lip 107 is fastened to the bottom portion 524 using a fastener 170. In the illustrated embodiment, the fastener 170 comprises a U-shaped member 172 having one leg pressing on the lip and being attached with a bolt 174. As such, the tank 100 may be attached at each bottom corners.

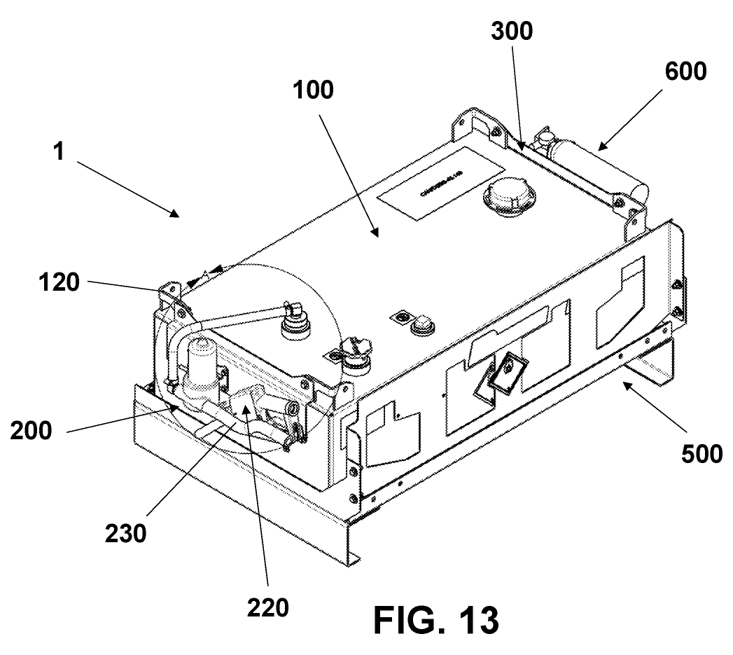

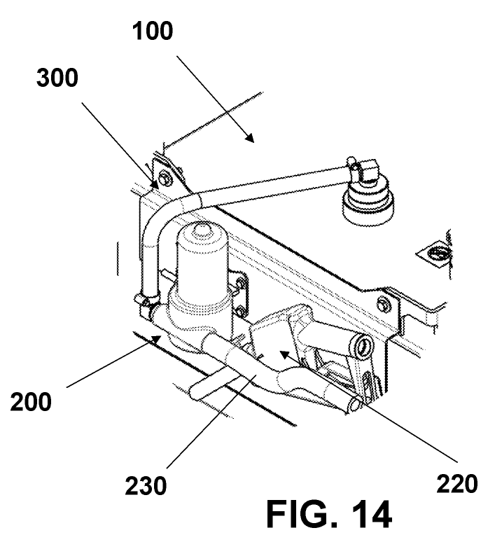

Referring now to FIGS. 13 and 14, yet another embodiment of a refueling system 1 mountable to a vehicle comprising a fuel nozzle assembly 220 mounted to a side bracket and attached to a rising assembly 400. In such embodiment, the fuel nozzle assembly 220 is mounted to the side mounting brackets 300 attached to two support brackets 120 of the tank 100. The fuel nozzle assembly 220 is positioned toward the front portion of the refueling system 1. In FIG. 13, the hose 230 is adapted to pass over the nozzle assembly 220 and toward the front of the tank 100. In such embodiment, the fire extinguisher 600 may be positioned to be rotated 90 degrees from the position as shown at FIG. 7. As such, the system 1 may fit under a cover of the bed of the truck. In such embodiment, the fire extinguisher bracket 320 may comprise a substantially horizontal member adapted to receive the fire extinguisher 600 and a Z-shaped portion 324 attachable to the side bracket 300.

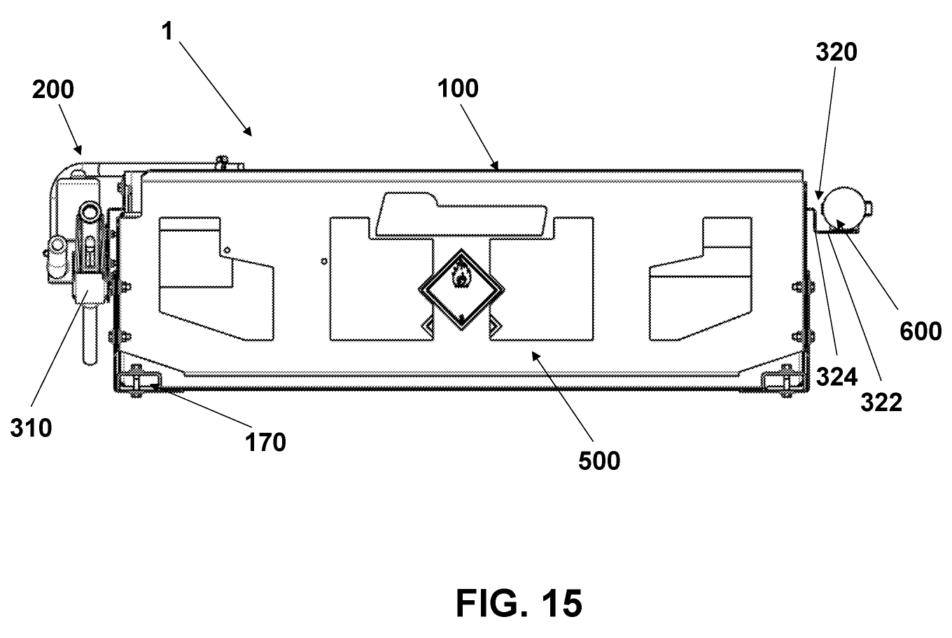

Referring now to FIG. 15, a further embodiment of a refueling system 1 mountable to a vehicle comprising a fuel nozzle assembly 220 mounted to a side bracket 300 toward the front of the system 1. In such embodiment, no rising assembly 400 is attached to the system 1. Similarly to the embodiment shown at FIGS. 13 and 14, the nozzle assembly 220 is positioned to be easily accessible from the bed of the truck by being mounted toward a front portion of the refueling system 1.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A portable fueling system mountable to a truck bed, the system comprising:
a fuel reservoir having a top portion;
a fuel delivery assembly connected to the fuel reservoir and mounted to the top portion of the fuel reservoir;
wherein the fueling system has a height equal or lower to the height of the truck bed.

2. The portable fueling system of claim 1 further comprising side mounting brackets, the fuel delivery assembly being mounted to the side mounting brackets.

3. The portable fueling system of claim 2, the reservoir comprising brackets protruding from a top portion of the fuel reservoir, the side mounting brackets being attached to the brackets of the reservoir.

4. The portable fueling system of claim 2 further comprising a nozzle assembly attached to the side mounting brackets below the top portion of the fuel reservoir.

5. The portable fueling system of claim 1 comprising two lower side mounting brackets attached to one or more lips of the fuel reservoir.

6. The portable fueling system of claim 1 comprising a protection assembly attached in front of the reservoir to prevent physical damages to the reservoir from items stored in the truck bed.

7. The portable fueling system of claim 6, the protection assembly comprising an enclosure between a front wall of the protection assembly and a front wall of the reservoir.

8. The portable fueling system of claim 7, the enclosure having a volume great enough to receive a dispensing hose of the fuel delivery assembly.

9. The portable fueling system of claim 6 comprising two lower side mounting brackets attached to one or more lips of the fuel reservoir, the protection assembly being attached to the lower side mounting brackets.

10. The portable fueling system of claim 1 comprising a rising assembly forming a storage area under the fueling system.

11. The portable fueling system of claim 10, the rising assembly comprising support members attached on at least two sides of the fueling system.

12. The portable fueling system of claim 11, the support members being C-shaped.

13. The portable fueling system of claim 10, the rising assembly being attached to one or more lips of the fuel reservoir.

14. The portable fueling system of claim 10 comprising two lower side mounting brackets attached to one or more lips of the fuel reservoir, the rising assembly being attached to the lower side mounting brackets.

15. The portable fueling system of claim 1, wherein the fuel reservoir is covered by a cover of the truck bed.

16. A method for carrying fuel under a covered truck bed comprising:
attaching a fuel reservoir in the truck bed, the fuel reservoir having a height
equal or lower than the height of the truck bed;
covering the truck bed and the fuel reservoir.

17. The method of claim 16 further comprising attaching a nozzle of the fuel reservoir below a top portion of the fuel reservoir.

18. The method of claim 17 further comprising mounting a fuel delivery system of the fuel reservoir below the top portion of the fuel reservoir.

19. The method of claim 16 further comprising storing a fuel hose of the fuel reservoir within a front protecting assembly.

20. The method of claim 16 further comprising the attachment of the fuel reservoir to allow an empty space under the fuel reservoir for storage.
